(19) United States
(12) Patent Application Publication
(10) Pub. No.: US 2018/0041840 A1
(43) Pub. Date: Feb. 8, 2018

(54) DIFFERENTIAL-CAPACITANCE TYPE MEMS MICROPHONE

(71) Applicant: GOERTEK.INC, Weifang City, Shandong (CN)

(72) Inventor: Guoguang ZHENG, Weifang City, Shandong (CN)

(73) Assignee: GOERTEK.INC, Weifang City, Shandong (CN)

(21) Appl. No.: 15/554,633

(22) PCT Filed: Dec. 10, 2015
(86) PCT No.: PCT/CN2015/096914

§ 371 Date: Aug. 30, 2017

(30) Foreign Application Priority Data
May 29, 2015 (CN) 201510290375.0

(51) Int. Cl. H04R 19/04; H04R 7/04; H04R 1/04; H04R 19/00

(52) U.S. Cl. CPC H04R 19/04; H04R 19/005; H04R 7/04; H04R 1/04; H04R 2201/003; H04R 2307/025; H04R 2410/01

(57) ABSTRACT

The present invention discloses a differential-capacitance type MEMS microphone, comprising a circuit board, a first MEMS chip and a second MEMS chip; wherein the first MEMS chip comprises a first substrate disposed on the circuit board, and a first capacitor disposed on the first substrate, the first capacitor comprising a first back pole plate located above, a first vibrating diaphragm located below, and a first isolating layer disposed between the first back pole plate and the first vibrating diaphragm; the second MEMS chip comprises a second substrate disposed on the circuit board, and a second capacitor disposed on the second substrate, the second capacitor comprising a second back pole plate located below, a second vibrating diaphragm located above, and a second isolating layer disposed between the second back pole plate and the second vibrating diaphragm; and the first capacitor and the second capacitor form a pair of differential capacitors.

### CROSS REFERENCE TO RELATED APPLICATION

This application is a national stage application, filed under 35 U.S.C. §371, of International Application No. PCT/CN2015/096914, filed on Dec. 10, 2015, which claims priorities to Chinese Application No. 201510290375.0 filed on May 29, 2015, the content of which is hereby incorporated by reference in its entirety.

### FIELD OF THE INVENTION

The present invention relates to a microphone, particularly to a differential-capacitance type micro electro-mechanical systems (MEMS) microphone.

### BACKGROUND OF THE INVENTION

A MEMS microphone is an electroacoustic transducer manufactured by a micromechanical machining technology, and it has advantages of small size, good frequency response characteristics, low noise, etc. With the trends of developing miniaturized and thinner electronic devices, the MEMS microphone is more and more widely applied to these devices.

A current MEMS microphone product comprises a MEMS chip based on capacitance detection and an ASIC chip, a capacitance of the MEMS chip will generate corresponding changes along with difference of input sound signals, and then the ASIC chip is used to process and output a changed capacitance signal, such that sound is pickup. The MEMS chip generally includes a substrate having a back cavity and a parallel plate capacitor disposed on the substrate and consisting of a back pole plate and a vibrating diaphragm. The vibrating diaphragm receives external sound signals and vibrates, such that the parallel plate capacitor generates a changed electrical signal, thereby realizing an acoustic-electrical conversion function.

Problems of the technical solution above are that single capacitance detection cannot filter external interference signals, a noise level of output signals is affected, and a higher signal-noise ratio cannot be achieved.

Therefore, there is a demand in the art that a new solution for a differential-capacitance type micro microphone shall be proposed to address at least one of the problems in the prior art.

### SUMMARY OF THE INVENTION

One object of this invention is to provide a differential-capacitance type MEMS microphone to reduce noise and improve a signal-noise ratio.

According to a first aspect of the present invention, there is provided a differential-capacitance type MEMS microphone, comprising a circuit board, a first MEMS chip and a second MEMS chip; wherein the first MEMS chip comprises a first substrate disposed on the circuit board, the first substrate being provided with a first opening running through from top to bottom; and a first capacitor disposed on the first substrate, the first capacitor comprising a first back pole plate located above, a first vibrating diaphragm located below and opposite to the first back pole plate, and a first isolating layer disposed between the first back pole plate and the first vibrating diaphragm; the second MEMS chip comprises a second substrate disposed on the circuit board, the second substrate being provided with a second opening running through from top to bottom; and a second capacitor disposed on the second substrate, the second capacitor comprising a second back pole plate located below, a second vibrating diaphragm located above and opposite to the second back pole plate, and a second isolating layer disposed between the second back pole plate and the second vibrating diaphragm; and the first capacitor and the second capacitor form differential capacitors together.

Alternatively or optionally, sensing parts of the first back pole plate and the second back pole plate are provided with a plurality of through holes respectively.

Alternatively or optionally, central positions of the first vibrating diaphragm and the second vibrating diaphragm are provided with a plurality of tiny through holes respectively.

Alternatively or optionally, the MEMS microphone further comprises a shell forming a packaging cavity body together with the circuit board, wherein the first MEMS chip and the second MEMS chip are located inside the packaging cavity body.

Alternatively or optionally, the shell is provided with a sound hole.

Alternatively or optionally, the circuit board is provided with a first sound hole in the position of the first opening, and is provided with a second sound hole in the position of the second opening.

Alternatively or optionally, a side of the circuit board combined with the shell is an inner side of the circuit board; the inner side of the circuit board is provided with a first sound hole connecting to the first opening and a second sound hole connecting to the second opening, respectively, and an outer side of the circuit board is provided with a third sound hole; and the third sound hole is located between the first sound hole and the second sound hole, the first sound hole is connecting to the third sound hole by a first passage, and the second sound hole is connecting to the third sound hole by a second passage.

Alternatively or optionally, the first back pole plate, the first vibrating diaphragm, the second back pole plate and the second vibrating diaphragm are all made of polycrystalline silicon material.

Alternatively or optionally, the first back pole plate, the first vibrating diaphragm, the second back pole plate and the second vibrating diaphragm are provided with a metal connecting point, respectively.

Alternatively or optionally, the MEMS microphone further comprises an ASIC chip disposed on the circuit board, the ASIC chip is provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm respectively.

The inventors of the present invention have found that there is still no differential-capacitance type MEMS microphone in the prior art. Thus, the present invention is a new technical solution. The differential-capacitance type MEMS microphone of the present invention can filter an external noise signal, improving the signal-noise ratio and the performance of a microphone product.

Further features of the present invention and advantages thereof will become apparent from the following detailed description of exemplary embodiments according to the present invention with reference to the attached drawings.

### BRIEF DESCRIPTION OF THE DRAWINGS

The accompanying drawings, which are incorporated in and constitute a part of the specification, illustrate embodiments of the invention and, together with the description thereof, serve to explain the principles of the invention.

FIG. 1 is a schematic diagram of a first embodiment of a differential-capacitance type MEMS microphone of the present invention.

FIG. 2 is a schematic diagram of the deformation of a vibrating diaphragm subjected to a downward action of a sound pressure of the first embodiment.

FIG. 3 is a schematic diagram of the deformation of a vibrating diaphragm subjected to an upward action of the sound pressure of the first embodiment.

FIG. 4 is a schematic diagram of a second embodiment of a differential-capacitance type MEMS microphone of the present invention.

FIG. 5 is a schematic diagram of a third embodiment of a differential-capacitance type MEMS microphone of the present invention.

### DETAILED DESCRIPTION OF THE EMBODIMENTS

Various exemplary embodiments of the present invention will now be described in detail with reference to the drawings. It should be noted that the relative arrangement of the components and steps, the numerical expressions, and numerical values set forth in these embodiments do not limit the scope of the present invention unless it is specifically stated otherwise.

The following description of at least one exemplary embodiment is merely illustrative in nature and is in no way intended to limit the invention, its application, or uses.

Techniques, methods and apparatus as known by one of ordinary skill in the relevant art may not be discussed in detail but are intended to be part of the specification where appropriate.

In all of the examples illustrated and discussed herein, any specific values should be interpreted to be illustrative only and non-limiting. Thus, other examples of the exemplary embodiments could have different values.

Notice that similar reference numerals and letters refer to similar items in the following figures, and thus once an item is defined in one figure, it is possible that it need not be further discussed for following figures.

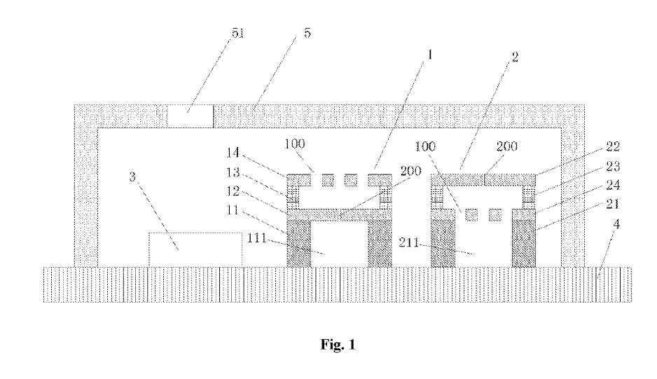

FIGS. 1-3 show a first embodiment of a differential-capacitance type MEMS microphone of the present invention.

A circuit board 4 and a shell 5 form a packaging cavity body, a first MEMS chip 1, a second MEMS chip 2 and an ASIC chip 3 are disposed inside the packaging cavity body, and the shell 5 is provided with a sound hole 51.

The first MEMS chip 1 comprises a first substrate 11 disposed on the circuit board 4, the first substrate 11 being provided with a first opening 111 running through from top to bottom; and a first capacitor disposed on the first substrate 11 and connected to the first substrate 11 in an insulating manner, the first capacitor comprising a first back pole plate 14 located above, a first vibrating diaphragm 12 located below and opposite to the first back pole plate 14, and a first isolating layer 13 disposed between the first back pole plate 14 and the first vibrating diaphragm 12 to keep a certain clearance therebetween.

The second MEMS chip 2 comprises a second substrate 21 disposed on the circuit board 4, the second substrate 21 being provided with a second opening 211 running through from top to bottom; and a second capacitor disposed on the second substrate 21 and connected to the second substrate 21 in an insulating manner, the second capacitor comprising a second back pole plate 24 located below, a second vibrating diaphragm 22 located above and opposite to the second back pole plate 24, and a second isolating layer 23 disposed between the second back pole plate 24 and the second vibrating diaphragm 22 to keep a certain clearance therebetween.

The first back pole plate 14 and the second back pole plate 24 are fixed pole plates, and the first vibrating diaphragm 12 and the second vibrating diaphragm 22 are movable pole plates.

Sensing parts of the first back pole plate 14 and the second back pole plate 24 are provided with a plurality of through holes 100, respectively. Central positions of the first vibrating diaphragm 12 and the second vibrating diaphragm 22 are provided with a plurality of tiny through holes 200, respectively, wherein the through hole 100 plays a role of conducting sound, and the through hole 200 plays a role of balancing air pressure.

The first back pole plate 14, the first vibrating diaphragm 12, the second back pole plate 24 and the second vibrating diaphragm 22 are provided with a metal connecting point, respectively. The ASIC chip 3 is provided with a first connecting part, a second connecting part and a third connecting part, wherein the first connecting part of the ASIC chip 3 is connected to the metal connecting point of the first back pole plate 14, the second connecting part is connected to the metal connecting point of the second back pole plate 24, and the third connecting part is connected to the metal connecting point of the first vibrating diaphragm 12 and that of the second vibrating diaphragm 22, respectively. The first capacitor and the second capacitor form a pair of differential capacitors. The first, second and third connecting parts for example, are pads.

In the MEMS microphone product of the present invention, the two MEMS chips are adopted to collect sound wave signals. These two MEMS chips are different, for one, the back pole plate is above and the vibrating diaphragm is below, and for the other one, the vibrating diaphragm is above and the back pole plate is below. The two MEMS chips form a pair of differential capacitors. When sound waves enter into the MEMS microphone, one capacitance of the first MEMS chip 1 and the second MEMS chip 2 is increased while the other one is reduced. The capacitance changes of the two MEMS chips are subjected to differencing so as to filter an external noise signal and improve a signal-noise ratio.

Specifically, a first capacitance of the first MEMS chip 1 is expressed as C1, a second capacitance of the second MEMS chip 2 is expressed as C2, when no sound wave action exists, C1=C2=C0. When the sound waves enter into the microphone from the sound hole 51, the followings will appear

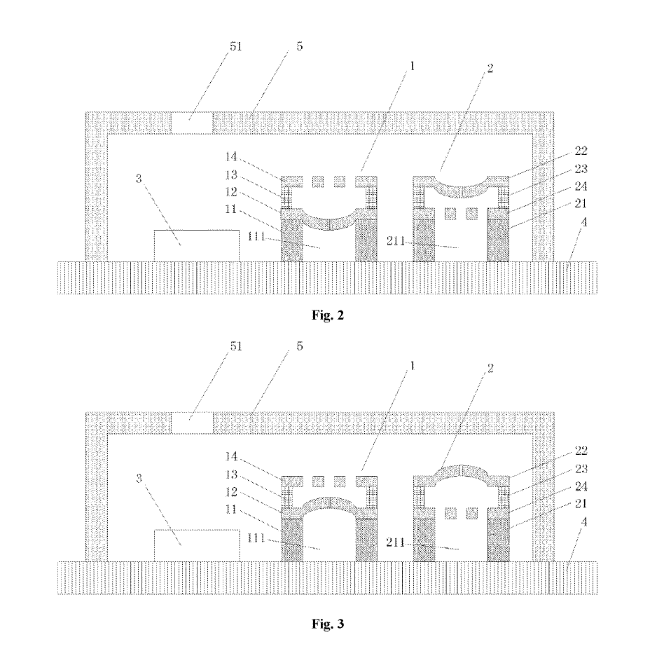

If a sound pressure has a downward action, referring to FIG. 2, the first vibrating diaphragm 12 moves downwards, resulting in a increase of an interval between the first vibrating diaphragm 12 and the first back pole plate 14 is increased, and a decrease of the first capacitance C1; and the second vibrating diaphragm 22 also moves downwards, resulting in a decrease of an interval between the second vibrating diaphragm 22 and the second back pole plate 24, and in a increase of the second capacitance C2. Therefore, the first capacitance C1 is smaller than C0, and C0 is smaller than the second capacitance C2, that is, C1<C0<C2.

If the sound pressure has an upward action, referring to FIG. 3, the first vibrating diaphragm 12 moves upwards, resulting in a decrease of an interval between the first vibrating diaphragm 12 and the first back pole plate 14, and in a increase of the first capacitance C1; and the second vibrating diaphragm 22 also moves upwards, resulting in a increasing of an interval between the second vibrating diaphragm 22 and the second back pole plate 24, and in a decrease of the second capacitance C2. Therefore, the first capacitance C1 is larger than C0, and C0 is larger than the second capacitance C2, that is, C1>C0>C2.

The first back pole plate 14, the first vibrating diaphragm 12, the second back pole plate 24 and the second vibrating diaphragm 22 are all made of polycrystalline silicon material; or the first back pole plate 14, the first vibrating diaphragm 12, the second back pole plate 24 and the second vibrating diaphragm 22 all include a silicon nitride layer and a polycrystalline silicon layer; or the first back pole plate 14, the first vibrating diaphragm 12, the second back pole plate 24 and the second vibrating diaphragm 22 all include a silicon nitride layer and a metal layer. The silicon nitride layer mainly plays a supporting role, and the polycrystalline silicon layer or the metal layer serves as a pole plate of the capacitor for use.

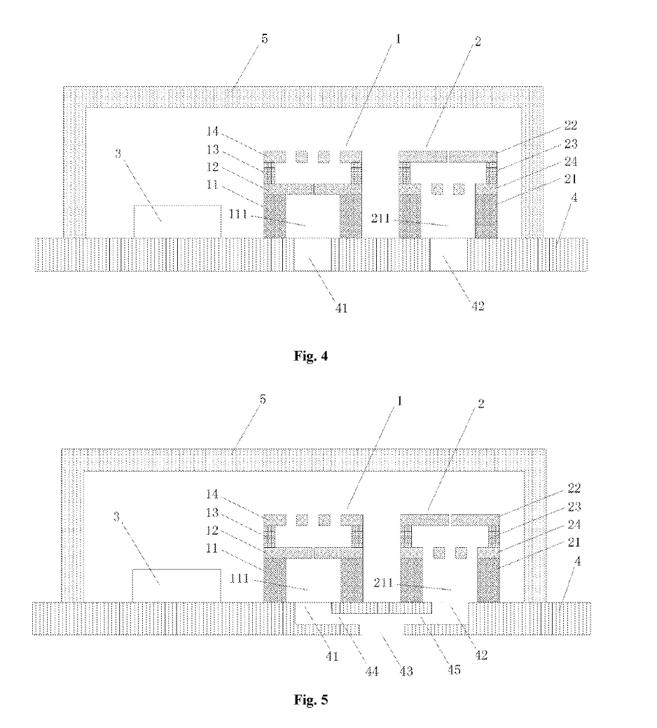

FIG. 4 shows a second embodiment of the differential-capacitance type MEMS microphone of the present invention, which differs from the first embodiment in that the microphone is changed to a BOTTOM structure from a TOP structure. The circuit board 4 is provided with a sound hole 41 of the first MEMS chip 1 in the position of the first opening 111, and is provided with a sound hole 42 of the second MEMS chip 2 in the position of the second opening 211, so that the requirement on sound incoming from the lower side of the microphone can be met.

FIG. 5 shows a third embodiment of the differential-capacitance type MEMS microphone of the present invention, which differs from the second embodiment in that one side of the circuit board 4 combined with the shell 5 is an inner side of the circuit board 4, and the other side is an outer side of the circuit board 4. The inner side of the circuit board 4 is respectively provided with a first sound hole 41 connected to the first opening 111 and a second sound hole 42 connected to the second opening 211, and the outer side of the circuit board 4 is provided with a third sound hole 43. The third sound hole 43 is located between the first sound hole 41 and the second sound hole 42, the first sound hole 41 is connected to the third sound hole 43 by a first passage 44, and the second sound hole 42 is connected to the third sound hole 43 by a second passage 45. In the third embodiment, the passages are made in the middle of the circuit board 4, such that the sound waves can enter into the third sound hole 43, can then reach the vibrating diaphragm of the first MEMS chip by the first passage 44 and the first sound hole 41, and can reach the vibrating diaphragm of the second MEMS chip 2 by the second passage 45 and the second sound hole 42. The solution can protect the MEMS chips to some extent, preventing dust or solid particles from entering into the MEMS chips to avoid damage to the vibrating diaphragms of the MEMS chips.

The differential-capacitance type MEMS microphone of the present invention can filter an external noise signal, improving a signal-noise ratio and the performance of a microphone product.

Although some specific embodiments of the present invention have been demonstrated in detail with examples, it should be understood by a person skilled in the art that the above examples are only intended to be illustrative but not to limit the scope of the present invention.

1. A differential-capacitance type MEMS microphone, the MEMS microphone comprising:
a circuit board, a first MEMS chip and a second MEMS chip,
wherein the first MEMS chip comprises a first substrate disposed on the circuit board, the first substrate being provided with a first opening running through from top to bottom; and a first capacitor disposed on the first substrate, the first capacitor comprising a first back pole plate located above, a first vibrating diaphragm located below and opposite to the first back pole plate, and a first isolating layer disposed between the first back pole plate and the first vibrating diaphragm;
the second MEMS chip comprises a second substrate disposed on the circuit board, the second substrate being provided with a second opening running through from top to bottom; and a second capacitor disposed on the second substrate, the second capacitor comprising a second back pole plate located below, a second vibrating diaphragm located above and opposite to the second back pole plate, and a second isolating layer disposed between the second back pole plate and the second vibrating diaphragm; and
the first capacitor and the second capacitor form differential capacitors together.

2. The microphone according to claim 1, wherein sensing parts of the first back pole plate and the second back pole plate are provided with a plurality of through holes respectively.

3. The microphone according to claim 2, wherein central positions of the first vibrating diaphragm and the second vibrating diaphragm are provided with a plurality of tiny through holes, respectively.

4. The microphone according to claim 1, the MEMS microphone further comprising, a shell forming a packaging cavity body together with the circuit board, wherein the first MEMS chip and the second MEMS chip are located inside the packaging cavity body.

5. The microphone according to claim 4, wherein the shell is provided with a sound hole.

6. The microphone according to claim 4, wherein the circuit board is provided with a first sound hole in the position of the first opening, and is provided with a second sound hole in the position of the second opening.

7. The microphone according to claim 4, wherein a side of the circuit board combined with the shell is an inner side of the circuit board; the inner side of the circuit board is provided with a first sound hole connecting to the first opening and a second sound hole connecting to the second opening, respectively, and an outer side of the circuit board is provided with a third sound hole; and the third sound hole is located between the first sound hole and the second sound hole, the first sound hole is connected to the third sound hole by a first passage, and the second sound hole is connected to the third sound hole by a second passage.

8. The microphone according to claim 1, wherein the first back pole plate, the first vibrating diaphragm, the second back pole plate and the second vibrating diaphragm are all made of polycrystalline silicon material.

9. The microphone according to claim 1, wherein the first back pole plate, the first vibrating diaphragm, the second back pole plate and the second vibrating diaphragm are provided with a metal connecting point, respectively.

10. The microphone according to claim 1, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

11. The microphone according to claim 2, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

12. The microphone according to claim 3, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

13. The microphone according to claim 4, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

14. The microphone according to claim 5, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

15. The microphone according to claim 6, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

16. The microphone according to claim 7, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

17. The microphone according to claim 8, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.

18. The microphone according to claim 9, the MEMS microphone further comprising, an ASIC chip disposed on the circuit board, the ASIC chip being provided with a first connecting part, a second connecting part and a third connecting part; wherein the first connecting part is connected to the first back pole plate, the second connecting part is connected to the second back pole plate, and the third connecting part is connected to the first vibrating diaphragm and the second vibrating diaphragm, respectively.
